(19) United States
(12) Patent Application Publication
(10) Pub. No.: US 2007/0016313 A1
(43) Pub. Date: Jan. 18, 2007

(54) Power supply controller

(76) Inventors: Yuuichi Abe, Mito (JP); Kimiaki Taniguchi, Nakai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/261,713

(22) Filed: Oct. 31, 2005

(30) Foreign Application Priority Data
Jul. 15, 2005 (JP) 2005-207537

(51) Int. Cl. G05B 11/01

(52) U.S. Cl. 700/22

(57) ABSTRACT

A power supply controller with a function to identify whether or not a signal that was output is reliable and to perform the necessary processing on the input side when an unreliable signal was sent that might adversely affect the input side in communication systems. A controller 1 and a controlled device 21 are connected at both ends of a cable 17 (27) with connectors. The controller contains a first processing system 1, a second processing system 2, and a comparator 7. The first processing system and the second processing system 2 are for example equivalent to microcomputers, etc. The comparator 7 compares the outputs of these two processors and generates a match/mismatch signal according to whether the outputs are a match or not. When the two outputs are a match then the outputs of these processors are reliable. However if the outputs are a mismatch then it signifies there is an error in one of these processing systems. Either of these processors outputs a general output signal separate from the match/mismatch signal. The general output signal may be output from either the first processing system or the second processing system without passing through the comparator. The general output signal is converted to a contact signal. The match/mismatch signal functions to turn the monitor signal on the monitor signal line on and off. The actual connection for this (output signal line) is shown in the drawings. The monitor signal line forms a loop on the monitor signal line for the signal to move back and forth between the controller and the controlled device. The controlled device contains an internal open-identifier for sensing whether the control signal line is open or closed.

### FIELD OF THE INVENTION

The present invention relates to power supply control technology for power supplies such as for power supply control of disk arrays and relates in particular to a power supply controller for sending and receiving contact signals as unreliable output signals that might adversely affect the input side in communication systems.

### BACKGROUND OF THE INVENTION

In power supply control technology such as for disk arrays, whether or not the contact signal being sent and received is reliable has traditionally been an extremely critical problem. FIG. 2 is a drawing showing the concept of contact signal. In FIG. 2, the transmit side 31 includes a power supply 35 and a switch 33, and the receive side 37 contains a light bulb 41. These components are connected together forming an electrical circuit and can transmit signals by utilizing the opening and closing a switch on the transmit side according to the information to be sent, and the light bulb on the receive side lighting up or turning off in the same way.

The switch 33 may electrically open or close the circuit, or may even be a mechanical relay or transistor. A light bulb 41 was described as an example of a component capable of detecting the opening/closing of the circuit however a LED may also be used. The power supply may also be installed on the receive side. In other words, the contact signal is a signal expressed by the opening/closing of the circuit.

A minimum of two lines are required for allowing the electrical current to flow back and forth in the circuit to send and receive the contact signal. However, when sending and receiving contact signal in multiple circuits, one line can be jointly used among the two lines along with the power supply 55 as shown in FIG. 3. The jointly used line at this time is called the common 57 and the non-jointly used line is called the signal line 61. The terminal connecting to the common on the transmit receive sides is called the common terminal, and the terminal connecting the signal line on the transmit side is called the output terminal, and the terminal connecting the signal line on the receive side is called the input terminal.

Methods for transmitting and receiving the contact signal may utilize a power supply on either the transmit side or the receive side, moreover, there is no polarity for either the switches 53a to 53c and the light bulb 67a to 67c as described in the example, and electrical current may flow in both directions. However, transistors and LEDs make use of polarity that only allows electrical current to flow in one direction so that methods for transmitting/receiving the contact signals can be grouped into four types according to whether the current flow is from the common 57 to the signal line 61 or from the signal line 61 to the common 57.

FIG. 4 is a drawing showing the four types of contact signal transmit/receive methods. Here, the numbers 1 and 2 are power supplies on the receive side 81, and the numbers 3 and 4 are power supplies on the transmit side 71. In the numbers 1 and 3, the electrical current flows from the common 77 to the signal line 75, and in the numbers 2 and 4 the electrical current flows from the signal line 75 to the common 77. In FIG. 4, the photocouplers 73 and 83 are utilized instead of the switch and light bulb. The photocouplers 73 and 83 are devices combining the LED 73a and 83a with the phototransistors 73b and 83b. The LED 73a and 83a emit light when the electrical current flows in the positive direction in the LED 73a and 83a, and the electrical current flows in the positive direction in the phototransistors 73b and 83b. By converting the electrical signal temporarily into light, the phototransistors 73b and 83b can be electrically isolated from the LED 73a and 83a.

In FIG. 4, the phototransistors 73b and 83b are utilized instead of the switches, and the LED 73a and 83a are utilized instead of the light bulbs. Utilizing any of the methods of numbers 1 through 4 allows installing the LED 73a and 83a, and phototransistors 73b and 83b, and power supplies in an appropriate direction versus the common 77 and the signal line 75.

[Patent document 1] JP-A No. 249258/1996

[Non-patent document 1] “Introduction to High Reliability Technology for Computer Systems” published by the Japanese Standards Association on Mar. 25^{th} 1988.

### SUMMARY OF THE INVENTION

However, when communicating with contact signals between two devices; consisting of a device A and a device B, signals are seldom sent just from the device A to the device B, or just from the device B to the device A. Usually signals are also sent from the device B to the device A, and from the device A to the device B. In this case, the device A and the device B both function as the transmit side and as the receive side, and both possess a number of input terminals and output terminals. The transmit/receive method from the device A to the device B, and the transmit/receive method from the device B to the device A are not always the same at this time. For example, if utilizing the No. 1 transmit/receive method of FIG. 4 from the device A to the device B, and utilizing the No. 3 transmit/receive method from the device B to the device A, then only the device B possesses a power supply and yields the benefit that the size can be reduced since the device A does not include a power supply.

In communications using these type of contact signals, specifications are established for the contact I/F. Communication is performed based on these contact I/F specifications. These contact I/F specifications include not only the previously described transmit/receive methods for contact signals respectively for transmitting and receiving, but also specifications for a number of input/output signal terminals and what protocol to use to transmit and receive these signals. These protocols provide the respective timing for opening and closing the contact signals being sent and received.

In cases where the signal line is disconnected due for example to the cable connector coming loose, or cases where an error has occurred in the processor (processing system) that interprets the open/close of the contact signal according to the protocol and generates the signal to be sent and a reliable signal cannot be generated, then not only is transmit/receive of the contact signal disabled but a signal with errors is sent. The detecting (sensing) in the case where the signal line (wire) is disconnected due to the cable coming loose performed the same as the conventional art and for example for recognizing that the connection is no longer made when a monitor signal line has opened is disclosed in JP-A No. 249258/1996.

FIG. 5 is a drawing showing a typical contrivance for detecting a broken or disconnected (electrically open) line. When the controller 101 of the system D outputs a contact signal to the controlled device 121, a technology is disclosed as shown in FIG. 5, for detecting whether or not the line for outputting that signal (input signal as seen from the controlled device 121) is disconnected or broken. The controller 101 and the controlled device 121 are connected by a cable 117 (127) equipped with connectors 115, 125 at both ends. The monitor signal line forms a round trip loop between the controller 101 and the controlled device 121.

Either the loop forward path or the return path may be used in common. Though no power supply is shown in FIG. 5, Either of the controller 101 or the controlled device 121 may contain a power supply. An open-identifier 123 of the controlled device 121 is equivalent to the LED of FIG. 4 or the light bulb of FIG. 2 and FIG. 3. The open-identifier 123 is capable of deciding whether the loop of the monitor signal line is opened or is closed. When this loop is open such as due to a broken line, then the open-identifier 123 can sense (detect) that the loop of the monitor signal line is broken due to the loop being open, or in other words can detect that the connector has come loose, etc.

The method of the conventional art in this way detects that the signal line 117 (127) is broken or disconnected due to the cable connector coming loose, etc. However, when an error occurred in the processor (processing system) for interpreting the opening or closing of the contact signal according to the protocol and generating the signal to be sent and reliable signals could no longer be generated, the receive side in the method of the conventional art possessed no means for detecting those unreliable signals.

A technology for improving the reliability of the processing system is introduced in 4.1.3 “Redundancy Methods” (Non-patent document 1) that utilizes various redundant system configurations and recovery techniques (Techniques with the aim of restoring and maintaining the required reliability standards of the system so that even if a fault occurs in the system structural components, the required system standards will not fall below those required for external services).

An example of triple redundancy for that technique is shown in FIG. 6. An identical input 131 is applied to the same three processing systems, and the majority circuit 141 obtains the majority count of the respective outputs from the processing systems 133, 135, 137 to determine the total output 143 for the entire system. Since this is fault masking (a technique for eliminating the fault effects by a fixed redundant configuration and constantly issuing a correct output externally) the correct output can be immediately obtained even if a fault occurs. However if a dual redundancy configuration is used instead of a triple redundancy, then the majority count cannot be obtained, since of course merely comparing the two outputs of each processing system only reveals that there is an error in either system and therefore has the problem that it cannot determine which processing system contains the error.

When a correct output cannot promptly be obtained in this way, error correction is performed and recovery is then attempted by retries, reconfiguration, and recovery processing according to the recovery flow in section 4.2 of “Introduction to High Reliability Technology for Computer Systems”. However, the correct outputs cannot be obtained from the system until recovery is complete. Methods where correct outputs cannot be obtained until recovery is complete are generally called active redundancy. Methods utilizing different types of redundancy belonging to this active redundancy are described in section 4.1.3 of “Introduction to High Reliability Technology for Computer Systems”. Methods classified as active redundancy generally possess the advantage of a low cost. However these methods also possess the great disadvantage that the system must be stopped during the period that correct outputs cannot be obtained. Though dependent on the type of communication method, the communication might be either interrupted or information containing errors might be communicated.

In simple protocols that impart meaning to the opening/closing of single signal lines such as for contact signals, the output issued during the period where correct outputs cannot be obtained is not only meaningless but also is highly likely to prove harmful. Because it delivers information that is not the desired information.

This invention has the object of providing a device for detecting unreliable signals on the side receiving those unreliable signals in power supply controllers such as disk arrays that transmit and receive contact signals, when an error has occurred in processing systems for generating the signal to be sent so that reliable signals cannot be generated.

In systems capable of only detecting output errors due to active redundancy as described above, in communication via a protocol where an output containing errors imparts information different from the intended information, a device is provided for detecting unreliable signals on the receiving side when an error occurs in the processing system interpreting the meaning of the opening/closing of the contact signal according to the protocol and generating the signal to be sent so that a reliable signal cannot be generated.

The communication system of this invention contains a monitor signal line for sending monitor signals showing that a reliable signal cannot be generated when an error occurs in the processing system for generating the signal to be sent. In other words, information relating to whether an output signal is reliable or not effects the monitor signal and can be conveyed to the other party transmitted. The other party transmitted decides based on the monitor signal, whether or not the transmitting source is in a state capable of transmitting a reliable control signal. If decided that the control signal is not reliable, then the control signal is ignored.

A power supply control system provided according to a first aspect of this invention includes: a controlled device, and a power supply controller for controlling the power supply of the controlled device by contact signals, and a communication cable for connecting the power supply controller and the controlled device, and a comparator installed within the controller for comparing the respective outputs of the first processing system and the second processing system and generating a match/mismatch signal showing whether or not the outputs match, and a monitor signal line installed between the controller and the controlled device for sending a monitor signal specifying whether or not to control the controlled device by a general output signal as the output from either the first processing system or the second processing system, and a switch for opening and closing the monitor signal line based on the match/mismatch signal.

The controlled device preferably contains an open-identifier for detecting the monitor signal. The structure of the controlled device is in that case characterized in that the switch and the open-identifier are connected in series. The switch triggered by a match/mismatch signal in the monitor signal and the open-identifier are here connected in series and the switch and the open-identifier 23 may be configured to mutually open when the output signal is unreliable (when there is a mismatch).

In another aspect of this invention, the power supply controller is provided for controlling the power of the controlled device by contact signals and is connected with the controlled device by communication cable and comprises: a comparator installed within the controller for comparing the outputs of the first processing system and the second processing system and generating a match/mismatch signal showing whether or not the outputs match, and a monitor signal line for sending a monitor signal specifying whether or not to control the controlled device by a general output signal as the output from either the first processing system or the second processing system, and a switch for opening and closing the monitor signal line based on the match/mismatch signal.

A controlled device controlled by the contact signals from the power supply controller and connected by a communication cable with the power supply controller is provided, wherein the controlled device includes an open-identifier for detecting a monitor signal specifying whether or not to control the controlled device from a general output signal comprised of either of the outputs of the first processing system and the second processing system.

The controlled device is characterized by an open-identifier for recognizing matches/mismatches and implements control by opening (the monitor signal line) when a mismatch occurs. The monitor signal line in this way also incorporates a function for detecting a disconnection in the signal line when for example a connector comes loose.

In another aspect of this invention, a communication system where unreliable signals might exert adverse effect on the input side contains a function on the output side for deciding whether an output signal is reliable or not, and contains a monitor signal for conveying whether the signal output from the output side is reliable or not, and is characterized in including a function to convey information relating to whether or not the output signal is reliable or not via a monitor signal to the other party transmitted.

The input side preferably performs specified pre-established processing when the monitor signal shows that the signal output from the output side is unreliable. This specified processing includes processing on the safe side and termination processing.

This invention makes the input side (receiving side) is capable of detecting when reliable signals cannot be generated due to an error occurring in the processing system for generating signals to be sent from the output (transmit) side. This invention therefore possesses the advantage that there is no need to stop the system even in a period where the control signals are unreliable and cannot be output correctly.

The present invention may be utilized as a power supply controller for disk arrays, etc.

### BRIEF DESCRIPTION OF THE DRAWINGS

FIG. 1 is a concept block diagram of the structure of the control system of the first embodiment of this invention;

FIG. 2 is a drawing showing the concept of the contact signal;

FIG. 3 is a concept view of the contact signals possessing a common (terminal);

FIG. 4 is pictorial diagrams showing four configuration for the transmit/receive method for contact signals;

FIG. 5 is a diagram showing a typical structure for a general control system;

FIG. 6 is a function block diagram showing a typical structure of the control system when using general triple redundancy;

FIG. 7 is a pictorial diagram showing the structure of the power supply control system of this embodiment;

FIG. 8 is a pictorial diagram showing the power supply control device of this embodiment;

FIG. 9 is a circuit block diagram of a power supply control device of this embodiment;

FIG. 10 is a pictorial diagram showing a typical circuit structure of the ISO shown in FIG. 9;

FIG. 11 is a pictorial diagram showing a typical circuit structure of the ISO shown in FIG. 9;

FIG. 12 is a pictorial diagram showing a typical circuit structure of the ISO shown in FIG. 9;

FIG. 13 is a pictorial diagram showing a typical circuit structure of the ISO shown in FIG. 9;

FIG. 14 is a schematic of the circuit structure for the I/O pin of the microcomputer:

FIG. 15 is a step chart showing one example of a protocol for contact control for devices for power supply regulation;

FIG. 16 is a step chart showing one example of a protocol for contact control for devices for power supply regulation;

FIG. 17 is a step chart showing one example of a protocol for contact control for devices for power supply regulation;

FIG. 18 is a block diagram showing the circuit structure during forming of the monitor signal taking the delay into account; and

FIG. 19 is a table showing the selector outputs.

### DETAILED DESCRIPTION OF THE PREFERRED EMBODIMENTS

The embodiments of the controller of this invention are described next while referring to the accompanying drawings. The controller for example is a control device for a disk array. FIG. 7 is a function block diagram showing the functions of the control device of the embodiment of this invention. The controller 215 for the system E shown in FIG. 7 can communicate with the control terminal 201 via the serial (RS-232C) port 212 and the LAN 211. The controller 215 receives instructions from the control terminal 201 and controls the power supply from the four devices 217a to 217d by means of the contact signals. The controller 215 of this embodiment includes an HTTP server (web server) function, and is capable of communicating with the control terminal 201 possessing an HTTP client (for example, web browser) function.

The controller 215 of the embodiment of this invention includes the functions of an SNMP agent and can communicate with the control terminal 201 as the NMS (network management system) containing the functions of an SNMP manager. The controller 215 of this embodiment can be accessed from the control terminal 201 by way of the modem 203, the telephone line 207, and the console server 205 via the serial line 212.

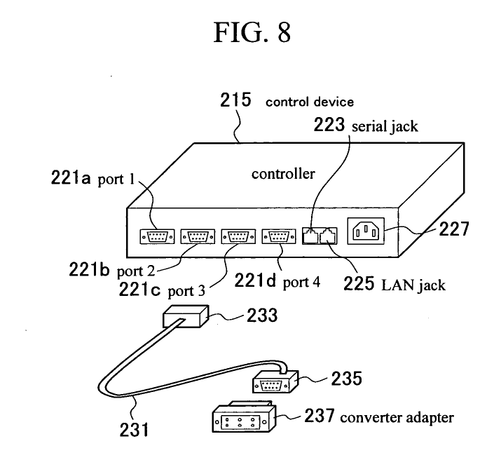

The controller 215 of the embodiment of this invention receives instructions from the control terminal 201 and regulates the power supply by using contact signals to sequentially turn the power supply on and off to the four devices 217a to 217d separately or linked together. Much electrical power is consumed when controlling the power for the controlled devices 217a through 217d by turning the power supply on and off, so the power supply must be turned on and off by utilizing a time differential. FIG. 8 is a perspective view showing the external structure of the controller of the present embodiment. The controller 215 of the present embodiment as shown in FIG. 8, contains one jack 225 and one jack 223 for connecting to the serial line, and connecting to the LAN, and possesses four ports 221a through 221d connected to form power supply controlled devices by the contact signal cable 231. The ports 221a through 221d and the cable 231 can utilize comparatively inexpensive and easily procured standard components such as the D-SUB 9 pin 233-235. An adaptable connector 237 may be utilized according to the power supply control device when the cable cannot be connected as is to power supply control devices with different shaped connectors.

The pin assignment (what signal to assign to what pin) as well as the shape of the adaptable converter 237 can be changed. The pin assignment can also be changed by the microcomputer software within the controller 215; however the assignment of the common terminal cannot be changed by the software. In cases where the signal assigned to each signal terminal can be changed, the change in pin assignment can also be made by the software.

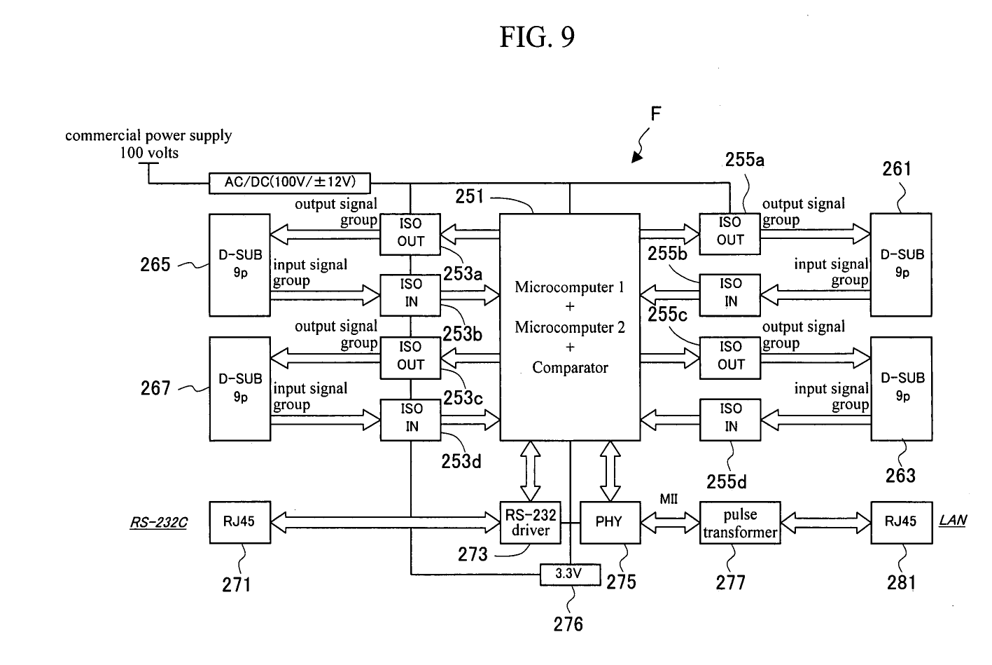

FIG. 9 is a function block diagram showing the structure of the printed circuit board F installed within the controller 215. A voltage of 100 volts is supplied from a commercial power supply on the circuit board. As shown in FIG. 9, the center of the controller 251 of this embodiment is comprised of two microcomputers made up of a microcomputer 1 and a microcomputer 2 forming a dual system for controlling the power supply, and a comparator for comparing the outputs (DO) of their I/O pins and detecting whether or not the results are a match. Besides the power supply processing, these microcomputers 1 and 2 process communications via the LAN and serial (RS-232C) port. When performing high-reliability control, the circuit voltage of the contact signal must to some extent be a high voltage and becomes higher than voltages such as the microcomputer utilized for control. Moreover the contact signal must be electrically insulated from the internal circuit by a photocoupler in view of the need to protect internal components such as the microcomputers. The insulation type ISO IN253b-253d-255b-255d, ISO OUT 253a-253c-255a-255c include photocouplers for input or output and their peripheral circuits respectively, and convert the 100 volts of the commercial power supply to ±12 volts, and supply it to each ISO IN, ISO OUT as the power for the contact signal. The ISO IN and ISO OUT are each connected to an input signal group and an output signal group for the contact signals of each of the ports 261, 263, 265, 267. The microcomputers are connected with PHY275 and the PHY is connected via the pulse transformer 277 to the RJ45 281, and the LAN. Moreover, the microcomputers are connected with the 3.3 volt power supply 277. The microcomputers are connected via the RS-232 driver 273 with the RJ45 271 and RS-232C.

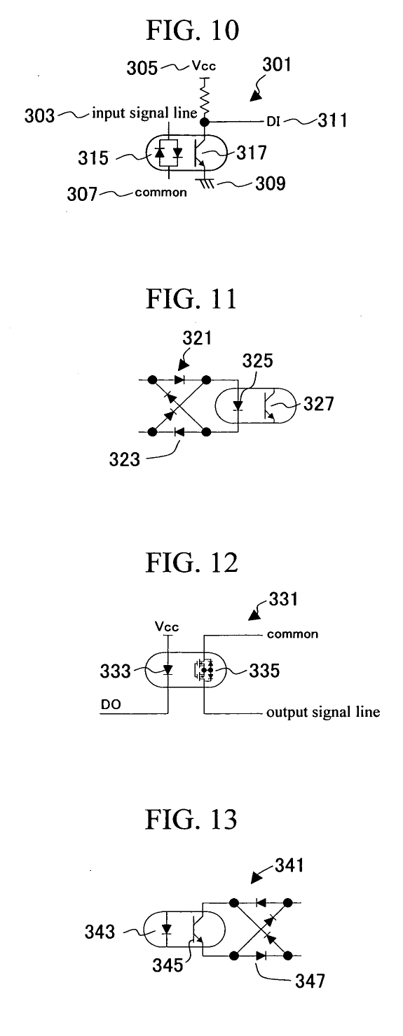

FIG. 10 shows connections such as the microcomputer input I/O pin (DI) 311 and the input photocouplers 315, 317 between the power supply Vcc 305 and GND 309. The two LED 315 of the photocouplers are each connected in parallel so as to face the opposite direction. One LED is connected to the input signal line 303 and other is connected to the common 307. One end of the phototransistor 317 is connected to the input line 303 and the other end is connected to ground (GND) 309. Either one of the two LED 315 can in this way emit light when the electrical current flows in either direction so that electrical current can be detected in both directions.

If the receiving method for the contact signal is predetermined then there is no need to set the electrical current flow in both directions but the circuit example shown here is a type capable of handling current in both directions. In the internal circuit insulated from the contact signal, the phototransistor 317 forms a new internal contact signal for supply to the input terminal (DI) 311 of the microcomputer. Instead of an input photocoupler for handling electrical current in both directions, a circuit 321 as shown in the circuit in FIG. 11 may contain functions identical to those of FIG. 10 using the diode bridge 323 and the uni-directional photocouplers 325 and 327.

FIG. 12 shows a typical connection using the output photocouplers 333 and 335, and the microcomputer output I/O pins (DO). The LED 333 is connected between the Vcc and DO, and the photocoupler 335 is connected between the common and the output signal line. These photocouplers 333 and 335 are also called photo-relays. The LED 333 on the microcomputer side is unidirectional in terms of current flow but the LED 335 on the output signal line side of the contact signal is bidirectional in terms of electrical current. Here, the same as for the input photocoupler, if the contact signal receive method is predetermined then there is no need to set the electrical current flow in both directions, but the circuit example shown here is a type capable of handling current in both directions.

Instead of an output photocoupler for bidirectional electrical current, the normal unidirectional photocouplers 343 and 345, and the diode bridge 347 can be used in a configuration as shown in FIG. 13.

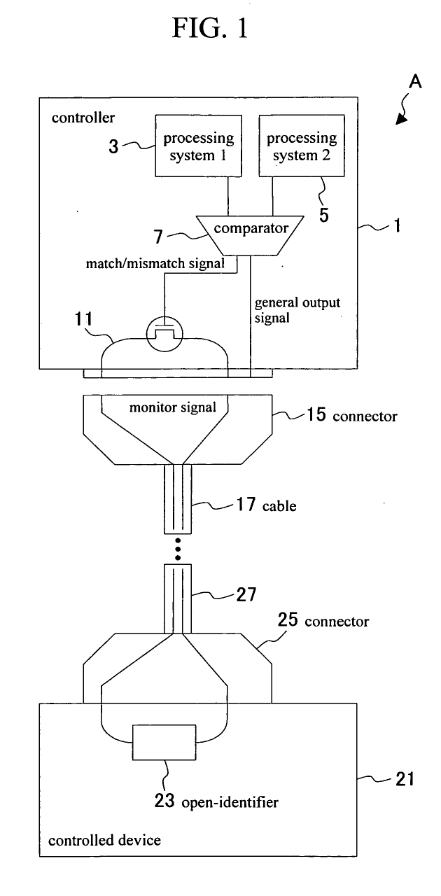

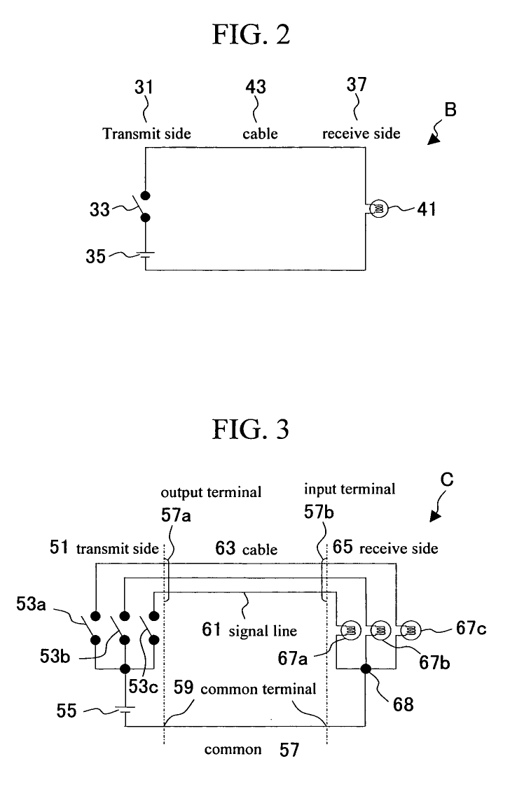

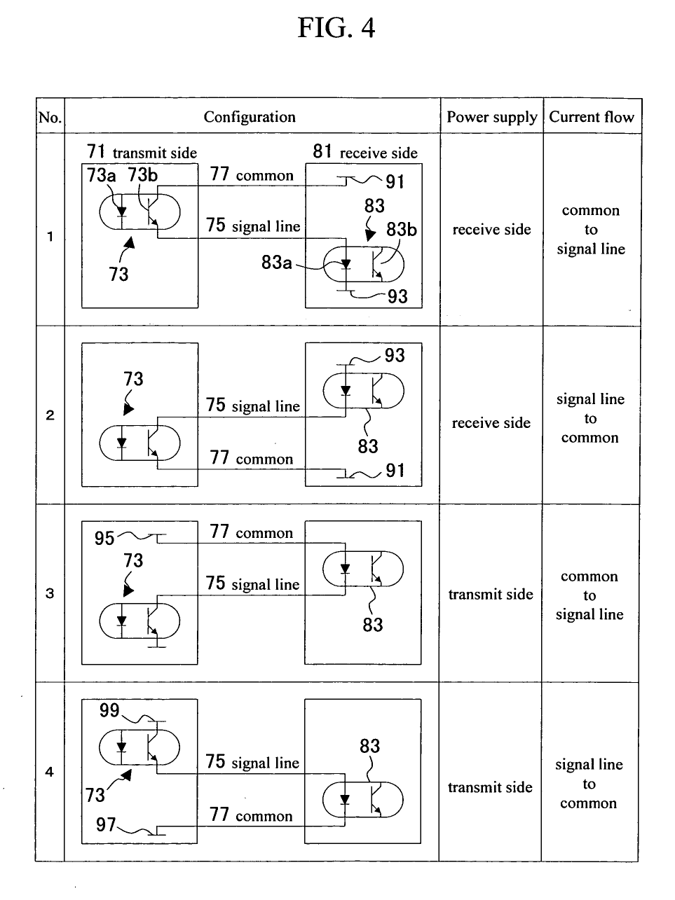

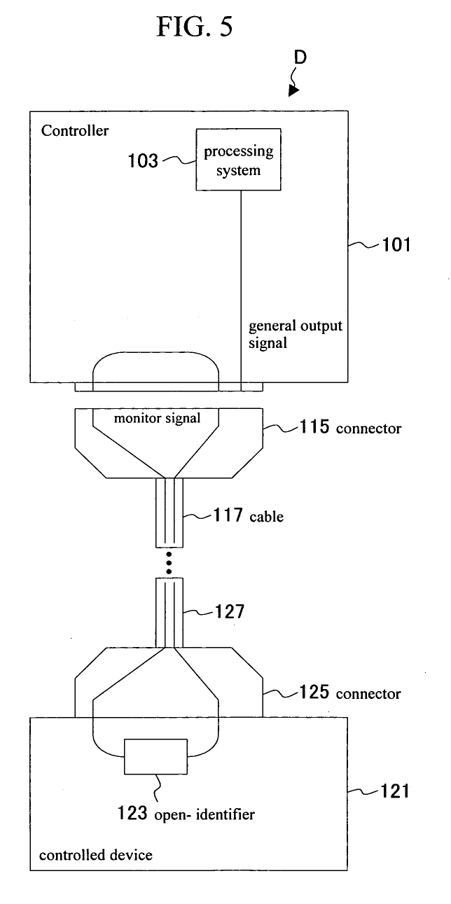

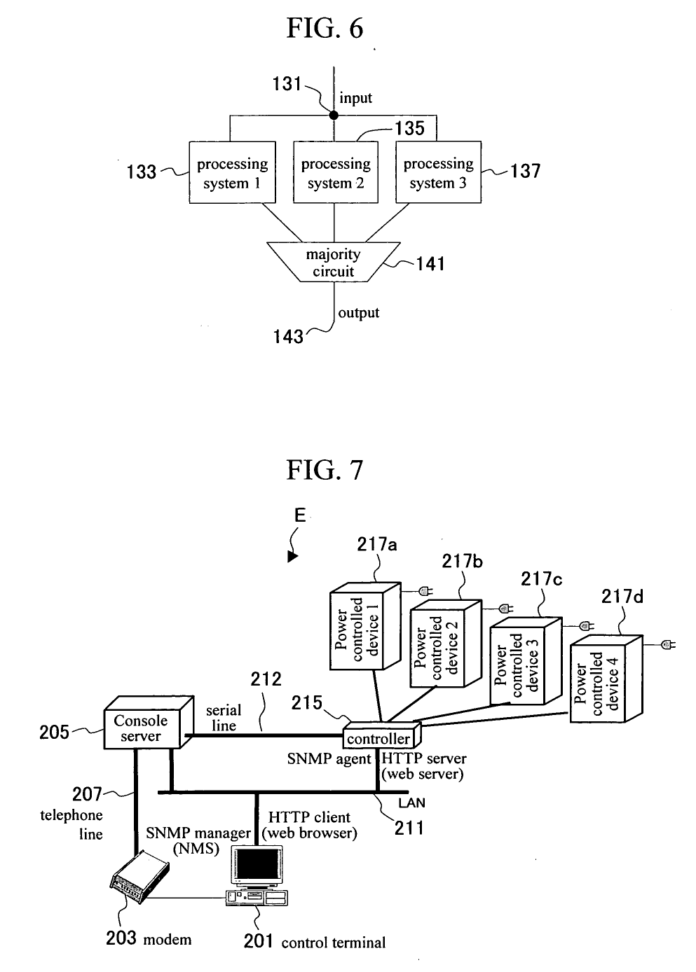

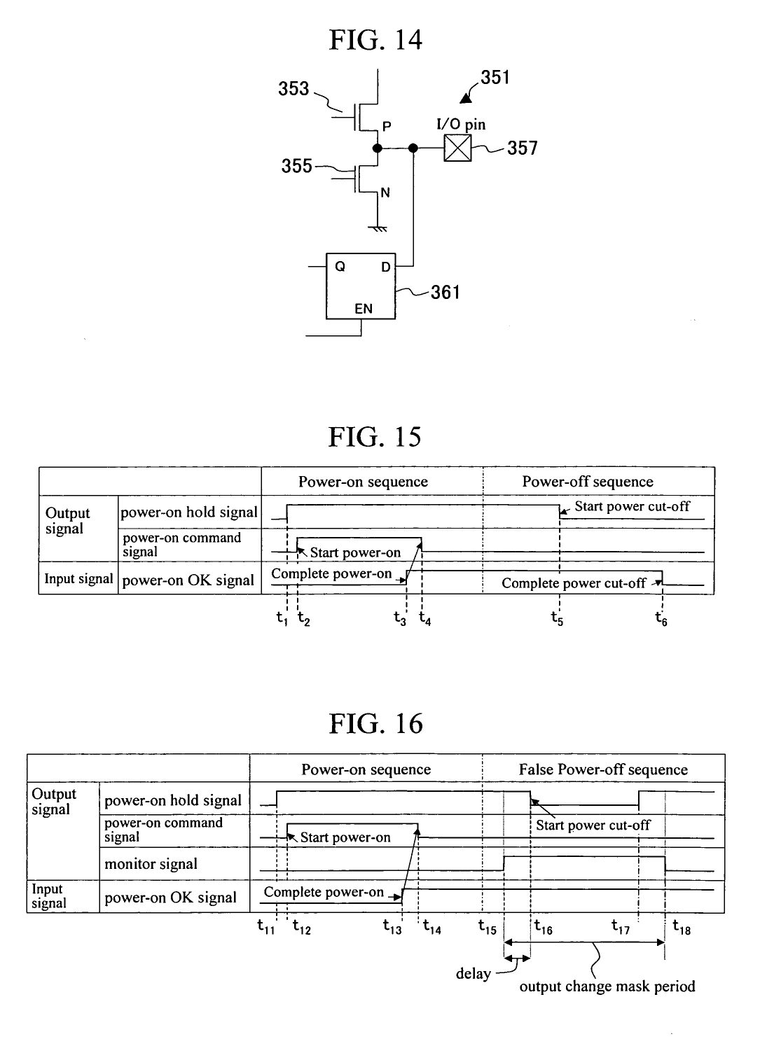

FIG. 14 is a diagram of a structure including microcomputer I/O pins. As shown in FIG. 14, the signal line utilized as the output is taken from a serial connection between a P-MOS 353 and an N-MOS 355 transistor. At least one of the two transistors 353 and 355 is controlled to set to an off state, and when the P-MOS 353 is, on the Vcc is applied to the signal line and when the N-MOS 355 is on, a ground is applied to the signal line. When both (MOS transistors) are off, the signal line possesses a high impedance and an input can be applied. When the signal input from the I/O pin 357 is input to the D-terminal of the through-latch 361 and the input enable signal input to the EN terminal is on, the input (DI) of the I/O pin is output unchanged to the Q terminal; and when turned off, the value of the I/O pin 357 when off is stored and output to the Q terminal. By setting the output to a high impedance in this way it can be jointly used with the input. A comparator 7 (FIG. 1) is mounted for the internal functions of each microcomputer and either of those outputs may serve as the comparator 7 output, and the comparator 7 may also be installed outside the microcomputer 7.

In cases where the comparator 7 is installed outside the microcomputer, the connection between the comparator 7 and the photocoupler may be the same connection configuration as the microcomputer and photocoupler as shown in FIG. 10 and FIG. 12.

FIG. 15 is a diagram showing one example of a protocol for contact control of one power supply controlled device 21 (FIG. 1). The power-on hold signal and the power-on command signal are output signal from the controller, and the power-on OK signal is an input signal to the controller. In the case of power on, in a state where the power-on hold signal turns on at time t1 and the power-on command signal is turned on at time t2, the power supply starts to supply power to the controlled devices, and at the point in time that power-on is completed, the power-on OK signal turns on at time t3. The power-on command signal then turns off at time t4. In the case of power-off, the power-on hold signal turns off at time t5, the turning off of power to the controlled device begins, and when turning off the power is completed at time t6, the power-on OK signal turns off. The above example including two output signals and one input signal was extremely simple however communication is in this way performed according to the protocol with the controlled devices each.

FIG. 1 shows the monitor signal for the system of the present embodiment in detail. The controller 1 and the controlled device (controlled equipment) 21 are connected to a cable 17 (27) equipped with connectors on both ends.

The controller internally contains a processing system 1, a processing system 2 and a comparator 7. The processing system 1 and the processing system 2 are for example equivalent to two microcomputers. The comparator 7 compares the two outputs of the processing systems and generates a match/mismatch signal according to whether the outputs match or not. When these outputs are a match it signifies that the outputs of the two processing systems are reliable. But when these outputs are a mismatch it signifies there is an error in one of the processing systems. The output for example of either the processing system 1 or processing system 2 serves as a general output signal separate from the match/mismatch signal. This general output signal may be output directly from either the processing system 1 or processing system 2 without passing through the comparator 7.

The general output signal is in fact converted to a contact signal as shown in FIG. 12. The match/mismatch signal functions to open or close the monitor signal on the monitor signal line. The actual connection is shown in FIG. 12.

The monitor signal line forms a forward and return path between the controlled device 21 and the controller 1. In FIG. 1, the forward path and the return path are shown as separate from other signal lines; however either of these forward or return lines may be jointly utilized with the common of other signal lines. No power supply for the contact signal is shown in this loop but in actual use a power supply may be installed at a position on the loop on either path.

An open-identifier 23 is installed within the controlled device 21 and is capable of detecting whether the monitor signal line is open or closed. The open-identifier possesses a structure for example as shown in FIG. 10. If the decision of the open-identifier 23 and the match/mismatch recognition are identical then the monitor signal line 11 may be set to open when the match/mismatch signals are a match, or the monitor signal line 11 may be set to open when the match/mismatch signals do not match. Either setting is acceptable. However if opened when these are not a match (There is an error in either one of the processing systems.) then the line opens the same as when there is a signal line disconnection due to a cause such as a connector coming loose, so that the monitor signal line may also possess a function for detecting an open line. In other words, the monitor signal line 11 opens when disconnected (line breakage, etc.) which is the same as the open-identifier 23 recognizes that the match/mismatch signals do not match and therefore the same processing can be performed as when an unreliable signal is output from the controller 1.

In FIG. 1, the monitor signal is sent from the controller 1 to the controlled device 21. However the controller 1 can also detect whether or not the signal sent from the controlled device 21 to the controller 1 is reliable. In this case, a monitor signal may be generated that is sent from the controlled device 21 to the controller 1 in a state where the controller 1 and controlled device 21 are completely interchanged with each other.

Moreover, if bidirectional monitor signals as described above are required, then the respective monitor signal lines may be jointly used. In that case, where the switch which acts on the monitor signal according to the match/mismatch signal, and the open-identifier 23 configured to be are connected in series, and may mutually open (the line) when the output signal is unreliable (a mismatch).

In the present embodiment, an example was utilized for an unreliable signal where the outputs of two processing systems were a mismatch. However, error detection results such as from active redundancy can all be used in place of the match/mismatch signal. In other words, it is important that information on whether the output signal is reliable or not effects the monitor signal and is conveyed to the party transmitted.

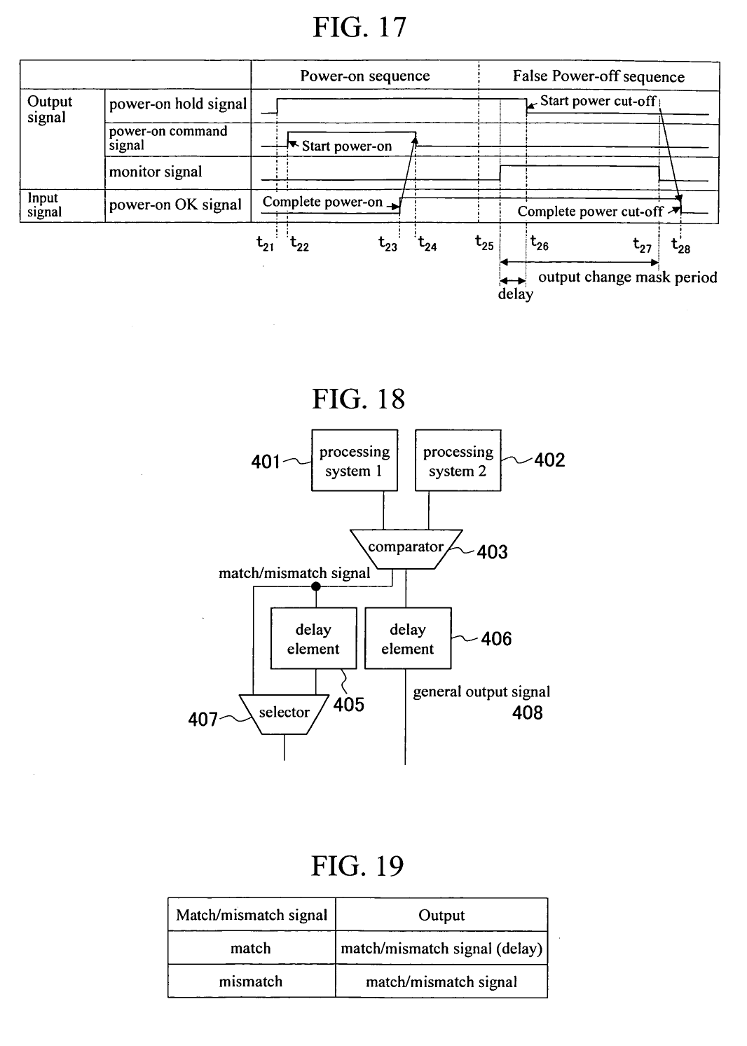

FIG. 16 and FIG. 17 are diagrams showing the operation of the controller 1 and the controlled device 21 when the monitor control signal is enabled (here, the output signal from the controller 1 (FIG. 1) is assumed to be showing an unreliable output.) in the power supply off sequence protocol shown in FIG. 15.

In these specifications, a “false power-off sequence” is a power-off sequence started in a state where the controller cannot send reliable signals and mistakenly turns off the power-on hold signal thus starting the power-off sequence. This is a false power-off sequence that was started by mistake so that some measure must be used to prevent the controlled device from receiving the mistakenly turned off signal as a real signal. The signal to fulfill that purpose is the monitor signal.

The “output change mask period” is a period where the power-supply controlled device ignores (masks) the change in output signals of the controller. The monitor signal is enabled (turns on) when the controller is in a state where it cannot send a reliable signal. Therefore, the power supply is not mistakenly turned on or off since the change in the controller output signals is ignored by the power supply controlled device, in the period where the monitor signal is on.

FIG. 16 is a diagram showing where the monitor signal is on when the power-on hold signal is off. At time t11 the controller turns the power-on hold signal on (high) and then starts turning on the power by setting the power-on command signal to on at time t12. When the controlled device 21 turns on the power-on okay signal at time t13, the controller 1 turns the power-on command signal off (low) in the subsequent time t14. The power supply on sequence is completed in this way and the controlled device enter into the power-on state.

The controller 1 next attains a state where reliable signals cannot be sent, and when the monitor signal is set to on at time t15, the power supply will not start to turn off even if the power-on hold signal was mistakenly set to off at the time t16, after a delay from time t15. Also, the controlled device 21 will ignore those changes even if the power-on hold signal was mistakenly set to on at time t17.

The controller then returns to a state where reliable signals can be sent. When the monitor signal turns off at time t18, the command from the controller 1 is again reflected at the controlled device 21. Here, the period from time t15 to time t18 is the output change mask period.

In other words, the controlled device 21 ignores output changes from the controller 1 (for example changes in the control signal at time t16, time t17) in the output change mask period resulting from the monitor signal turning on. The controlled device 21 continues to ignore changes in the output from the controller 1 until the monitor signal turns on once again. When the monitor signal turns off, the controlled device 21 again performs processing according to the output from the controller 1.

In FIG. 16, when the output from the controller is no longer reliable, the monitor signal is immediately enabled (turns on)(time t15), and the arrival time (t16) of the unreliable output is delayed more than the arrival time t15 of the monitor signal. The arrival timing of the output signal and the monitor signal are in this way made not to approach each other via racing and so prevents the possibility that output changes will not be securely masked. The controller 1 performs retry and recovery processing in the period that the monitor signal is enabled (high) and once again disables the monitor signal after a reliable output is achieved. In other words, the monitor signal is not generated by directly applying the error detection results; rather it must be generated by processing the error detection results as needed. For example, as was described above, a delay may incorporated between the error detection results such as for the match/mismatch signal and the general output signal, and when an error is detected, the monitor signal must be made to start up earlier than the output signal. In other cases, it may be necessary to merge the error detective results and signals relating to on-going retry or recovery processing.

In other words, rather than simply reflecting error detection results in the monitor signal, it is a preferable signal specification that a monitor signal reports information on whether an output is reliable or not, so that the party receiving the signal utilizing the monitor signal can perform the appropriate processing according to the signal reliability. Here, the processing on the receive side when the monitor signal is enabled, functions to ignore (mask) signal changes in that period however, among other measures, the appropriate processing can be performed according to the system. For example, the processing on the receive side may be set to ignore signal changes within a specified period when the monitor signal is enabled (on), however when the monitor signal is continually on for a time longer than that fixed period then the processing may effect a shutdown. Another method is to notify the user and urge the appropriate processing be performed. How the monitor signal is utilized may differ depending on the system.

In FIG. 17, the monitor signal is enabled (on) in the power supply off sequence in the same way as in FIG. 16. However, the example in FIG. 17 shows a change in the power-on hold signal after the monitor signal turns off. In other words, the controller 1 turns on the power-on hold signal at time t21, and afterwards turns on the power-on command signal at time t22 to commence turning the power on. When the power controlled device 21 turns on the input signal for the power-on OK signal at time t23, the controller 1 turns off the power-on command signal at the subsequent time t24. The power-on sequence is in this way terminated and the power controlled device enters into the power-on.

The controller next reaches a state where reliable signals cannot be sent and when the monitor signal turns on at time t25, and the power supply will not cut off at the subsequent time t26, even in cases where the power-on hold signal was mistakenly set to off.

Next, when the controller 1 returns to a state where reliable signals can be sent, the monitor signal turns off at time t27, and the output change mask period ends. In this case, since the power-on hold signal from the controller 1 is off at this time, the input signal from the power controlled device 21 also turns off at time t28. The output change mask period is from time t25 to t27. In this type of case, the controlled device 21 that is the receiver of the signal, first recognizes that the power-on hold signal has turned off when the monitor signal is disabled (turned off), and shuts off the power supply.

The timing when the monitor signal turns off is therefore critical. The monitor signal must definitely be enabled (turn on) during the period that an unreliable signal is output from the controller 1, and therefore in some cases it is necessary to disable (turn off) the monitor signal with a slight delay after the recovery to a reliable output. This delay may of course be controlled from the transmit side or the receive side so that if clearly being performed on the receive side, then there is no need to create a monitor signal that allows for this delay. Also, if the monitor signal allows for a delay, then even if small signal changes of a reliable signal are output in the period that the monitor signal is on, the receive side might not recognize those changes. In other words, a delay (time t25 to t26) must be introduced, and reliable signals longer than that period (time t28) must be changed so that changes in reliable signals will not be masked by the monitor signal.

Generating a monitor signal that allows for a delay is therefore important. A typical circuit configuration used when generating a monitor signal in considering on a delay is shown in FIG. 18. As shown in FIG. 18, the circuit for forming the monitor signal allowing for a delay, includes a processing system 401 and a processing system 402, and a comparator 403 for comparing the outputs of these processing systems, and a selector 407 for selecting and outputting a signal with a delay added by the delay element 405 and a signal without a delay to the match/mismatch signal from among the outputs from the comparator 403, and obtain a general output signal 408 including a delay added by the delay element 406 from among the outputs of the comparator 403. The general signal from the comparator 403 is output via the delay element 406. The selector 407 however selects match/mismatch signals that passed through or did not pass through the delay element 405.

The output of the selector 407 is shown in FIG. 19. As can be seen in this figure, those outputs that passed through the delay element are selected to output when match/mismatch signals were a match, otherwise those (match/mismatch signal itself) that did not pass through are selected and output. If the delay time that the delay element delays the match/mismatch signal is set to a longer delay time than the delay element of the general signal, then the monitor signal can completely mask the general signal during the period that it is unreliable. The case of a match/mismatch signal was described here, however signals during retries and recovery processing may also be handled the same way.

In this embodiment, the case was described where the signal was a contact signal however, providing a monitor signal as shown in the embodiment is effective when a function is provided on the output side for identifying whether or not the output signal is reliable, and an unreliable signal might exert adverse effects on the input side. Also, disconnections such as from a connector that has come loose can be simultaneously detected even without contact signals. For example, signal specifications may be utilized where the monitor signal can be set to alternating signals during normal operation and the alternating signals turned off when an unreliable output has been sent.

The disk array controller of the above embodiment is therefore capable of detecting loose connectors by the addition of a monitor signal line. Moreover, the controller renders the advantage that when dual processing systems are possibly outputting unreliable results, that condition can be detected by a simple and inexpensive structure, and can be reflected in the results.

The embodiments were described by means of examples however this invention is not limited to these examples. For example, the use of contact signals was described however other objects or means other than contact signals may be utilized.

What is claimed is:

1. A power supply control system which includes a controlled device; a power supply controller for controlling the power supply of the controlled device by contact signals; and a communication cable for connecting the power supply controller and the controlled device, comprising:
a comparator installed within the controller for comparing the respective outputs of a first processing system and a second processing system and generating a match/mismatch signal showing whether or not the outputs match;
a monitor signal line installed between the controller and the controlled device for sending a monitor signal specifying whether or not to control the controlled device by a general output signal as the output from either the first processing system or the second processing system; and
a switch for opening and closing the monitor signal line based on the match/mismatch signal.

2. A power supply control system according to claim 1, including an open-identifier installed in the controlled device for detecting the monitor signal.

3. A power supply control system according to claim 2, wherein the switch and the open-identifier are connected in series.

4. A power supply control system according to claim 2, wherein the general output signal is converted to a contact signal.

5. A power supply control system according to claim 1 wherein, in the period that the monitor signal is on, the controlled device ignores changes in the output from the controller in the period that the output from the two processing systems are different.

6. A power supply control system according to claim 1 wherein, the monitor signal period where the signal output from the output side is unreliable, is actually longer than the period where the output side is actually outputting the unreliable signal.

7. A power supply control system according to claim 1 wherein, the monitor signal includes a means for notifying external sections that the signal output from the output side is unreliable.

8. A power supply control system according to claim 1, wherein the system performs specified pre-established processing on the input side when the monitor signal shows that the signal output from the output side is unreliable, and the processing is towards the safety side or is termination processing.

9. A power supply control system according to claim 1, wherein the input side ignores changes in the signal output by the output side, in the period where the monitor signal shows that the signal output by the output side is unreliable.

10. A power supply control system according to claim 1, wherein when the period where the monitor signal shows that the signal output by the output side is unreliable, is shorter than a predetermined period, the input side ignores changes in the signal output by the output side, and when the predetermined period was exceeded, the input side performs the specified, predetermined, processing.

11. A power supply controller for controlling the power of a controlled device by contact signals, and the power supply controller is connected with a controlled device by a communication cable, comprising;
a comparator installed within the controller for comparing the outputs of a first processing system and a second processing system and generating a match/mismatch signal showing whether or not the outputs match;
a monitor signal line for sending a monitor signal specifying whether or not to control the controlled device by a general output signal as the output from either the first processing system or the second processing system; and
a switch for opening and closing the monitor signal line based on the match/mismatch signal.

12. A power supply controller according to claim 11, wherein the monitor signal line further includes a function of detecting disconnections or breakage in the communication cable.

13. A controlled device controlled by contact signals from a power supply controller, and connected to a communication cable, wherein the controlled device includes an open-identifier for detecting monitor signals for commanding whether or not to control the controlled device by a general output signal output from either a first processing system or a second processing system.

14. A controlled device according to claim 13, wherein the ropen-identifier performs control by opening the monitor signal line when a mismatch occurs based on the match/mismatch recognition.

15. A communication system including a function installed on the output side for deciding if the signal output from the output side is reliable or not in communication systems where unreliable signals might adversely affect the input side, and also including a monitor signal for informing the input side on whether the signal output from the output side is reliable or not, wherein
the communication system includes a function for applying information relating to whether the output signal is reliable or not to the monitor signal, and informing the party transmitted.

16. A communication system according to claim 15, wherein the monitor signal period where the signal output from the output side is unreliable, is actually longer than the period where the output side is actually outputting the unreliable signal.

17. A communication system according to claim 15, wherein the input side performs specified, predetermined processing when the monitor signal shows that the signals output from the output side are unreliable.

18. A communication system according to claim 15, wherein the input side ignores changes in the signal output by the output side when the monitor signal shows that the signals output from the output side are unreliable.

19. A communication system according to claim 15, wherein the input side ignores changes in the signal output from the output side when the period where the monitor signal shows that the output side is outputting unreliable signals, is shorter than a predetermined period; and
the input side performs specified, predetermined processing when the unreliable output signal period exceeds the predetermined period.
